(19) United States
(12) Patent Application Publication
(10) Pub. No.: US 2009/0259561 A1
(43) Pub. Date: Oct. 15, 2009

(54) Method and System for Correlation of Product Quantities to Multiple Ship-to Addresses for a Single Online Order

(76) Inventors: Donald Robert Martin Boys, Redding, CA (US); Susan Araiza-Boys, Redding, CA (US)

Correspondence Address: CENTRAL COAST PATENT AGENCY, INC, 3 HANGAR WAY SUITE D, WATSONVILLE, CA, 95076, US

(21) Appl. No.: 12/103,415

(22) Filed: Apr. 15, 2008

(51) Int. Cl. G06Q 30/00

(52) U.S. Cl. 705/26; 705/1

(57) ABSTRACT

A system for facilitating data entry and submission of an Internet-based ecommerce transaction includes a computing node having Internet access to an ecommerce server; and a secure memory drive removably coupled to the computing node for storing payment information, address information, and an interactive interface for recording data into forms and cross filling data between two or more forms. The system is characterized in that the memory drive is activated by an authentication procedure during an online transaction such that after authentication, information stored on the drive can be used to complete, to record for receipt, and to submit an ecommerce order form using the interactive interface, the form submission including a supplementary electronic form detailing accounting of quantities of items ordered to be shipped to different shipping destinations.

### CROSS-REFERENCE TO RELATED APPLICATIONS

NA

### BACKGROUND OF THE INVENTION

1. Field of the Invention

The present invention is in the field of e-commerce and pertains particularly to methods and systems for correlating multiple ship-to address with product quantities in a single order placed with an online merchant.

2. Discussion of the State of the Art

In the field of e-commerce, web-based merchants have relied on automated shopping carts and checkout interfaces for aggregating a customer's purchased items and for totaling the price and shipping of those items (before shipment). Generally, an order form or online checkout interface focuses on item number and price tally. Shipping is added on depending upon the address the products will be shipped to from the warehouse.

Many web-based storefronts use the basic system for fulfilling online orders and for accepting payment from customers generally before products are shipped. One drawback of this system is that a customer typically must place a separate order for any items that the customer wishes to be shipped to any address other than the customer's default shipping address.

In the reality of online shopping, many customers are shopping for items that they intend ultimately to send to friends or relatives. In the current system all of the items for one order must be shipped to one shipping address and the customer may then re-ship items to their intended destinations. If a customer wishes to drop ship items to multiple destinations, then multiple orders must be placed with the system to match the items with the correct shipping addresses.

In the first case above, the customer pays shipping to one address and then has to repackage and ship items to other addresses themselves. In the second case, the customer has to incur the time and hassle of placing multiple orders and rendering multiple credit card or e-payment transactions, each costing the customer some amount of money.

Therefore, what is clearly needed in the art is a system and methods for accounting for multiple ship-to addresses for items placed in a single online order so there is but one payment and multiple shipments made on the order. A system such as this would save the customer money and bring in new clients for the Web merchants offering the capability.

### SUMMARY OF THE INVENTION

The problem stated above is that many customers desire an ability to drop-ship to multiple addresses in a single online transaction where on payment is rendered for the entire order containing the multiple shipments, but many of the conventional means for fulfilling online purchases, such as merchant shopping cart and transaction pages do not allow for subdividing an order unless multiple transactions result. The inventors therefore considered functional elements of an online shopping network, looking for elements that could potentially be harnessed to provide a customer with the convenience of configuring multiple shipping destinations into a single online order but in a manner that would not create significant extra work for a customer or a merchant and that would protect the identity and security of both the customer and the merchant.

Success of every online store front depends on the ability of attracting customers, one by-product of which is an abundance of new orders and avenues to expand the customer base. All online shopping sites employ server-side software to conduct the sales transactions initiated by their online customers in a secure manner.

The present inventor realized in an inventive moment that if, at the point of transaction, multiple ship-to addresses could be associated with smaller amounts specified of total product numbers ordered for each product ordered in a secure manner, significant convenience for the customer and merchant opportunities to expand customer base might result. Furthermore, transaction security might be improved by exposing customer data fewer times relative to multiple shipments.

The inventor therefore constructed a unique online shopping system for ecommerce sites that allowed customers to place a single order containing items ordered in numbers and to split the order among multiple shipping destinations without significantly affecting the traditional ordering process already in place and in some cases, without affecting the traditional ecommerce process at all. A significant benefit for both the customer and the merchant results, with no impediment to online security or accounting methods created.

Accordingly, in one embodiment of the present invention a system is provided for facilitating data entry and submission of an Internet-based ecommerce transaction comprising a computing node having Internet access to an ecommerce server, and a secure memory drive removably coupled to the computing node for storing payment information, address information, and an interactive interface for recording data into forms and cross filling data between two or more forms. The memory drive is activated by an authentication procedure during an online transaction such that after authentication, information stored on the drive can be used to complete, to record for receipt, and to submit an ecommerce order form using the interactive interface, the form submission including a supplementary electronic form detailing accounting of quantities of items ordered to be shipped to different shipping destinations.

In another embodiment a system for correlating specified quantities of items ordered in a single ecommerce transaction with shipping addresses comprising a server node hosting at least one ecommerce site connected to a network, an electronic shopping cart utility accessible to the server node for listing line items and total quantities for purchase, an electronic shipping interface accessible to the server node replicating each line item and quantity of the shopping cart utility and containing added fields in each line, at least one for specifying item sub-quantities and one for identifying a shipping address. The shipping interface calculates line item and total shipping charges for the transaction and correlates the correct item quantities to the correct shipping addresses.

In one aspect of the invention a method is provided for subdividing a single online order containing one or more line items to account for shipping and/or handling charges and item quantities to be shipped to more than one shipping address comprising the steps (a) defining the list of items and total quantities for each item ordered, (b) for each line item, specifying sub-quantities for shipping to a destination address, (c) for each line item of step (b), specifying the destination address for each sub-quantity, (d) for each line item of step (c), calculating the shipping and/or handling costs for each sub-quantity and shipping address, and (e) summing the shipping and/or handling cost sub-totals to account for the total shipping and handling charge for the order.

According to another aspect of the invention a method is provided for transferring data between electronic forms stored on and served from disparate network storage devices comprising the steps, (a) from a network connected computing node, accessing a server and invoking a first electronic form, the form containing pre-populated data in one or more data fields, invocation thereof resulting in display of the form including the data on a display screen of the network-connected computer, (b) from the computing node of step (a), executing a program, the program serving a second electronic form, the program and form residing on a drive local to the computing node, (c) auto filling data populated into the one or more fields of the first electronic form into one or more subject-appropriate fields of the second electronic form, (d) inserting additional data into one or more additional fields of the second electronic form, and (e) auto filling all or a portion of the additional data of step (d) into the one or more subject-appropriate fields of the first electronic form overriding any previous data in one or more of the fields.

In another aspect of the invention a method is provided for securing personal data for the purpose of later accessing the data for use in an online transaction comprising the steps (a) on a computer peripheral storage device, providing a user authentication device, at least one executable application, and at least one rule specifying how authentication works to allow device and application access, (b) connecting the peripheral storage device to a computer host, (c) from the computer host, gathering personal data and offloading the personal data onto the peripheral storage device, and (d) deactivating the computer peripheral device.

### BRIEF DESCRIPTION OF THE DRAWING FIGURES

FIG. 1 is a block diagram illustrating an online shopping system practicing multi-address shipments for a single order according to an embodiment of the present invention.

FIG. 2 is a block diagram illustrating an online shopping system similar to the system of FIG. 1 including a configurable e-shop address book according to an embodiment of the present invention.

FIG. 3 is a process flow chart illustrating steps for completing an online order according to an embodiment of the invention.

FIG. 4 is an elevation view of an interface for configuring a multiple ship address order according to an embodiment of the invention.

FIG. 5 is an elevation view of an interface for configuring a multiple ship address order according to another embodiment of the invention.

FIG. 6 is a process flow chart illustrating steps for configuring an online order for multiple shipping addresses according to an embodiment of the invention.

FIG. 7 is an architectural view of an online shopping network according to another embodiment of the present invention.

FIG. 8 is a process flow chart illustrating steps 800 for practicing multiple ship-to addressing for a single order according to the embodiment of FIG. 7.

### DETAILED DESCRIPTION

The inventor provides a network-based electronic shopping system and methods for enabling multiple shipping addresses for a single online transaction. The system in several aspects and methods are described in enabling detail using the following examples.

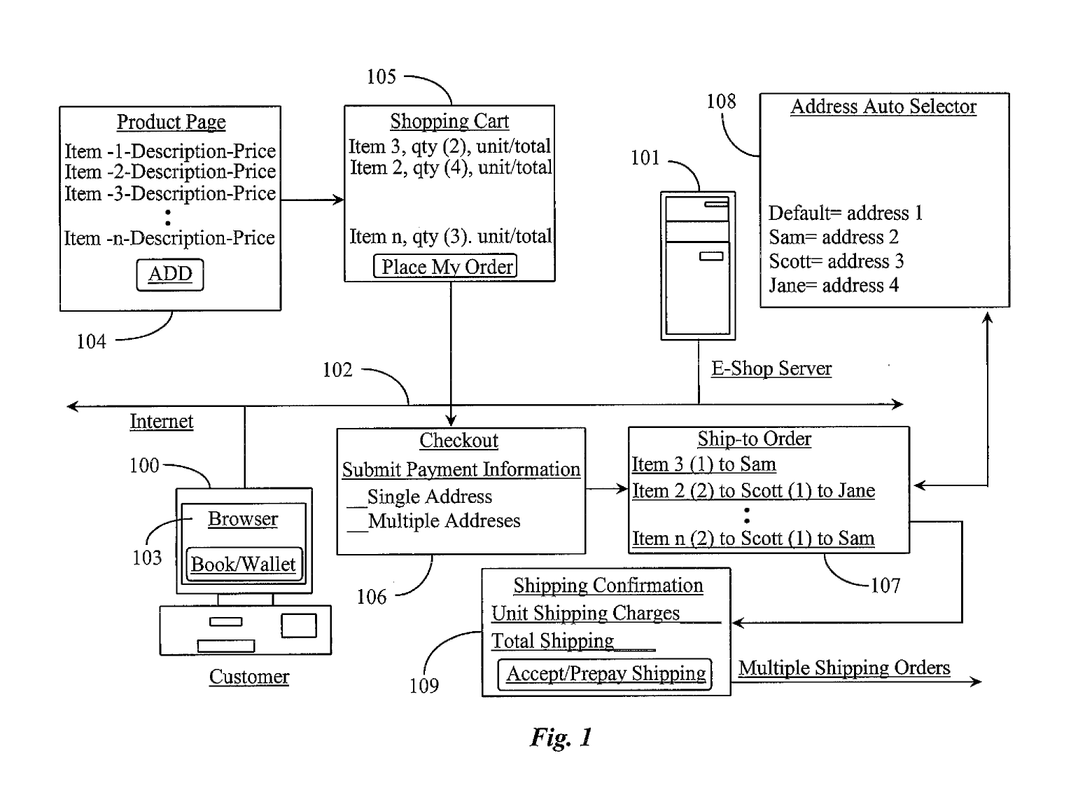

FIG. 1 is a block diagram illustrating an online shopping system practicing multi-address shipments for a single order according to an embodiment of the present invention. In this example an online shopping system architecture is logically illustrated and includes an ecommerce or “e-shop server” 101 connected to the well-known Internet network represented herein by a network backbone 102. e-commerce server 101 represents any server adapted to provide e-commerce “store fronts” or online stores for any number of merchant-based businesses. Server 101 may host multiple online shopping Web sites for clients that offer goods and services for purchase over the network.

Server 101 includes all of the software required to fulfill orders made online through merchant store fronts by consumers including electronic catalog or product listings or postings, electronic shopping cart utility, and customer checkout utility. Database facilities and servers as well as other network-connected equipment are represented by server 101.

A customer station 100 is illustrated in this example and includes a desktop computer connected to network backbone 102 by an Internet access line. Network backbone 102 represents all of the lines, equipment, and access points that make up the Internet network as a whole including any connected sub-networks. Therefore, there is no geographic limitation to the practice of the present invention.

Computer station 100 is enabled to navigate network 102 by a browser application 103 and the appropriate network access components. Computer station 100 may connect to Internet 102 using any one of a number of known Internet access services and connect methods. Station 100 may connect to the Internet using dial-up, digital service line (DSL), cable/modem, broadband, satellite, or other known methods and services including wireless access through a wireless fidelity access point (WiFi) or through a wireless municipal area network (MAN).

The typical process for online shopping involves the customer (100) connecting online to Internet 102 and then establishing a network connection with the aid of browser 103 to server 101 and to a universal resource locator URL of a store front Web page served by server 101. In a typical process the customer would navigate through two or more served pages of the merchant site in the process of creating and submitting an online order for products. For example, the customer may first register with the site as a customer before shopping. The customer may then browse through product listing or catalog pages that contain product representations and description including pricing.

The customer may select or highlight items and click an adjacent interactive control to add that item to an electronic shopping cart causing the shopping cart instance to open for the customer. The customer may proceed to a secure checkout page once the customer is finished adding products into the electronic shopping cart. The customer generally provides payment information and a shipment address for that single order.

A problem stated above in the background section is that the customer has no ready tools available online for ordering special shipping such as breaking up the product quantities ordered and separating them for multiple ship-to addresses. Typically, all of the products in the order will be shipped to a single address and the customer will be charged shipping and handling to that address and the total price for all of the products and product quantities ordered.

The inventor provides a service feature and methods that, in one embodiment, may be incorporated into standard online shopping server software to provide a system and service that allows a customer to conveniently order specific numbers of products in an order to be drop-shipped to specific ship-to addresses. Shipping and handling costs are then calculated according to the multiple shipment destinations of the revised order resulting in multiple drop shipments of parts of the order.

In practice of the invention, when customer 100 enters server 101 they may access a product catalog page 104 to add products to a shopping cart facility illustrated herein as shopping cart 105. Product page includes a reference to the item, an item number, an item description, and an item price for each listed item on the product page. By highlighting an item and clicking ADD, the item is placed into shopping cart 105.

In this example the selected items appear in list form in shopping cart facility 105. The first product in the list is Item 3, order quantity (qty) (2), with a unit price and a total price calculated for each line (unit/total). The customer has also ordered item 2, qty (4) and item n qty (3). After all of the items are dropped into the shopping cart, and the correct unit amount and total amount is calculated for each product, the client may proceed to purchase those products in the quantities ordered by clicking on PLACE MY ORDER taking the client to a checkout page 106.

On checkout page 106, the total order may be reviewed for accuracy and the customer may see the total price charged for the order before submitting any payment information. In this example the client may submit payment information in a served electronic form (not illustrated). Typically the customer may pay by credit card or online account service such as Pay Pal™.

In one embodiment after submitting payment information, an option for indicating the shipping parameters of the order is made to the customer. In this case no shipping or handling charges have been calculated for the order thus far. The customer may indicate by interactive selection whether there is to be one shipping address or multiple shipping addresses for the order. If there is one shipping address, the customer provides the address and the shipping and handling are calculated accordingly. If the customer selects multiple addresses, a special ship-to order page 107 appears in the customer interface for configuring the shipping parameters.

Ship-to order page 107 lists the items in the exact sequence of the shopping cart and provides at least one sub-quantity field or the ability for the customer to insert a sub-quantity field by allowing the customer to type in opposing parenthesis and then populating those with a number. In this example for item 3, the customer has chosen 1 of those items for shipment to a specific address. For each line item, ship-to order page 107 also includes one or more fields for adding an address that corresponds to the sub-quantity elected. A field may accept more than one shipping address and system correlation of a shipping address to a sub-quantity entered may be sequential. For example, a sub-quantity is entered and then a shipping address is entered. In this example, the customer has typed the name Sam to indicate the ship-to address for qty 1 of the total units ordered of item 3.

The system may recognize the correct shipping address for Sam typed in to the field by having access to or system knowledge of a customer address book listing specific shipping addresses for specific individuals. This information may be stored locally by the customer in an address book that may be combined, for example, with an electronic wallet such as a Yahoo™, or Google™ e-wallet containing secured payment information only used over a secure connection. An address book wallet combination is illustrated as a plug-in to browser 103.

The customer may have a list of friends and family that the customer often buys for such as during the holidays, for example. The shipping addresses for each name in the list may be entered in association with the name. By submitting a name into a field on ship-to order page 107, the system may automatically access the customer's address book portion of the E-wallet plugged into browser 103 and retrieve the correct shipping address. This can be accomplished using a provided routine labeled Address Auto Selector illustrated herein as element 108. The names and addresses in the address portion of the customer E-wallet are provided in association with one another by line. The default address (Default)=address 1, which may be the customer's address. The addresses for Sam, Scott, and Jane are also listed as address 2, 3, and 4 respectively. In other embodiments the correct shipping addresses may be retrieved other ways as will be detailed later in this specification.

The second line item on page 107 refers to item 2 of the order. Of 4 total units, the customer designates 2 to ship to Scott and 1 to ship to Jane. Any amount of the line left over may be shipped to the customer by default assuming the system already has the customer's preferred shipping address. If not the customer may supply that address in the same way as the others by entering a sub-quantity and designation his or her own name. The customer designates item n (2) shipping to Scot and (1) shipping to Sam. That is the total for that line according to the shopping cart so nothing will ship to the customer address for that item.

Shipping and handling charges may be automatically calculated correctly once the system has all of the sub-quantities and shipping addresses entered on the ship-to order page or form 107. Server 101 may serve a shipping confirmation page 109 to the customer interface to get approval of the customer for the total shipping and handling charges to be added to the order according to the entered shipping parameters. This confirmation page may break down unit shipping and handling charges for each shipping address and may provide the total charge for the order. The customer may then click on “Accept or Prepay Shipping” (if required) to generated a single shipping instruction document for the order, or to generate multiple separate shipping orders, one for each included address.

In this example all of the feature templates used in the practice of the invention namely checkout 106, ship-to order 107, address auto selector 108, and shipping confirmation 109 are provided and integrated into the normal order fulfillment software running on server 101 accept for the e-wallet plug-in that resides on computer 100 but is accessible to the merchant system through browser 103 during a transaction process. The catalog page and the shopping cart utility do not require any modification in order to practice the invention. The system enables a customer to direct multiple drop-shipments for a single order and payment.

In one embodiment a merchant may offer reduced shipping and handling charges or rebates of those charges for any of the customer's friends or family that are willing to accept solicitation from the merchant or who eventually become customers of the merchant and place orders independently with the merchant. Such an arrangement provides convenience to the consumer and a convenient way for the merchant to obtain more customers. The merchant need not change any part of the process for customers who do not elect multiple shipping addresses for an order. Single shipment orders are processed without the benefit of the invention.

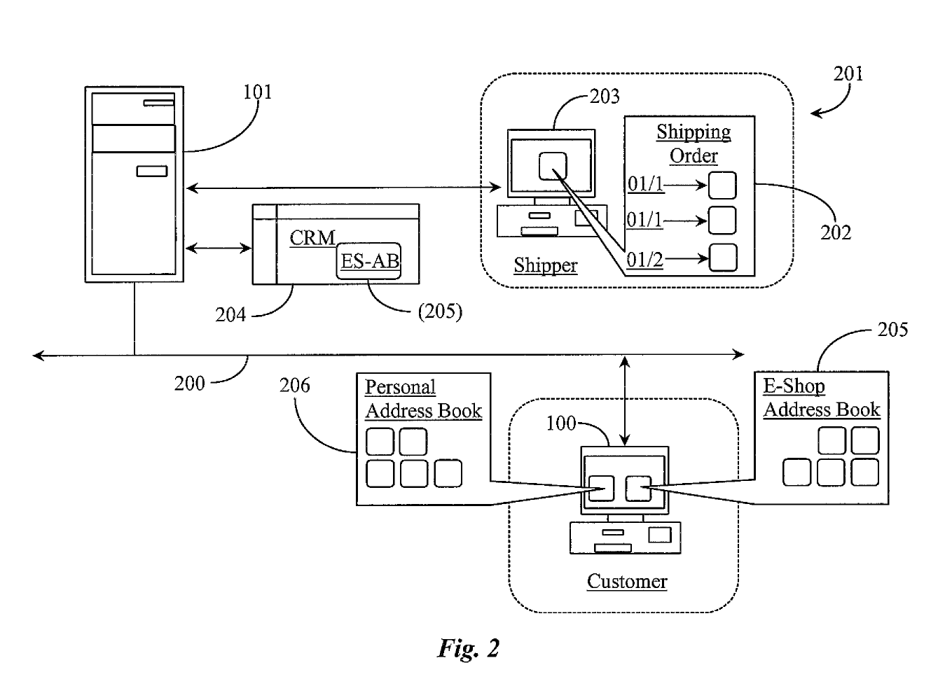

FIG. 2 is a block diagram illustrating an online shopping system similar to the system of FIG. 1 including a configurable e-shop address book according to an embodiment of the present invention. In this example the architecture illustrated includes a shipping entity 201 and a customer relations management database 204.

Server 101 and a customer operating computer station 100 are connected in session engaged in a transaction over Internet 102 as previously illustrated in FIG. 1. In this example, the merchant maintains an e-shop address book (ES-AB) 205 for the customer in CRM database 204. The customer may access address book 205 from CRM 204 through server 101 at any time and may edit the book by removing or adding entries to the book.

In this example the customer has a personal address book open and displayed on the display screen of computer 100. Personal address book 206 may contain objects as entries represented by names, pictures, avatars, or other visual indicators that may serve to identify the individual. The customer also has accessed and displayed the customer's e-shop address book 205 containing entries that may be objects compatible with both containers. In this example the customer may edit e-shop address book 205 by deleting an entry from book 205. The customer may add an entry to book 205 from book 206 by drag and drop method. Double clicking an entry in either book may call up an interface for viewing and editing the address parameters like changing a zip code, for example.

Objects representing the addresses may be placed into order forms over or next to indicated sub-quantities to enable the merchant server to correlate the correct address to the indicated item and sub-quantity elected for shipment to that address. Referring now back to FIG. 1, instead of entering a name associated with an address into ship-to order form 107, the customer may simply drop a picture/object of the person next to the sub-quantity to be shipped to that person. Referring now back to FIG. 2, the system will recognize the address as long as the address object is represented in E-shop address book 205. In another embodiment of the invention a spoken name may be used if the merchant system is enabled for voice input. The invention may also be practiced over an interactive voice response (IVR) connected to a telephony interface or other voice interface where the customer may say a name the system recognizes for that customer enabling the system to input the shipping address associated with the spoken name.

Shipper 201 includes a shipping terminal 203 that is adapted to receive shipping orders from the merchant site. A shipping order 202 is illustrated displayed on the screen of the terminal. Shipping order 202 contains the multiple ship-to instruction resulting from a single online transaction made by a customer operating computer 100. In this case item 01 has qty 1 shipping to one entry, qty 1 shipping to another entry, and qty 2 shipping to a third entry. In one embodiment the shipper may also be enabled to access the customer e-shop address book 205 or may simply be enabled by an object reader to expand the picture or avatar to print the associated address. In another case order 202 has the physical ship-to addresses already printed out. In another embodiment multiple separate orders (one for each address) are generated as was described further above.

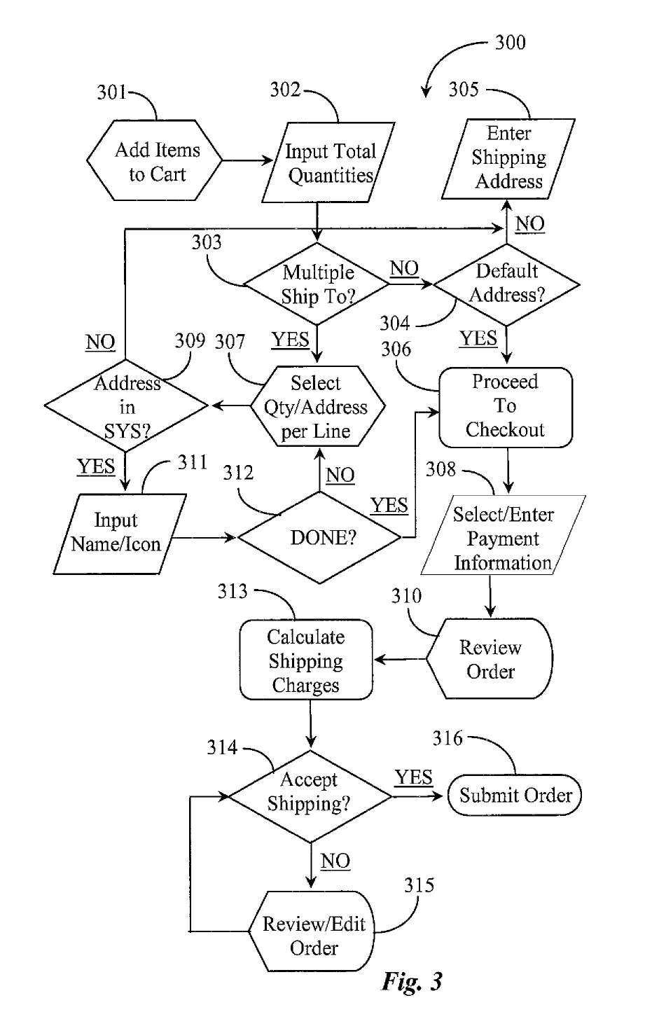

FIG. 3 is a process flow chart illustrating steps 300 for completing an online order according to an embodiment of the invention. At step 301 a customer adds items to an electronic shopping cart. This step assumes that the customer is connected with the merchant server and is selecting products to add to the cart from an electronic catalog or product list. At step 302, the customer inputs the total quantities for each item added to the cart. Steps 301 and 302 may be repeated in sequence for each product added to the shopping cart.

At step 303 the customer makes a decision as the result of a system prompt or election whether there will be more than one (multiple) ship to addresses for the transaction. If the customer decides that there will not be more than one shipping address for the transaction, the system decides if there is a default shipping address on file for the customer. If there is no default shipping address for the customer already known to the system then at step 305 the customer may be prompted to enter a shipping address for the transaction. In this case, all of the customer's products ordered are shipped to the single address entered.

If there is a default shipping address on file for the customer determined at step 304, the customer may proceed directly to checkout at step 306. Step 305 immediately precedes step 306 if the customer enters a shipping address for the transaction. The rest of the process for completing the order for a single transaction with only one shipping address is unremarkable and not relevant to the present invention. At step 308 the customer selects or enters payment information. At step 310 the customer may review the order. At step 313 the system may calculate the shipping and handling charges. At step 314 the customer may make a decision whether or not to accept the shipping and handling charges. If the customer accepts shipping and handling at step 314, the process moves to step 316 where the customer may submit the order. If at step 314, the customer does not accept the shipping and handling charges then at step 315 the customer may review and edit the order, perhaps selecting a different shipping method.

Referring now back to step 303, if the customer decides to break up the item quantities for multiple shipping addresses, the customer may select or enter one or more sub-quantities and provide one or more shipping addresses per line item of the order using methods described further above such as entering the information on a ship-to order form or page. For each address provided, the system may make a determination as to whether a provided address is known to or is accessible to the system. For example, a customer may enter the wrong name for an address or may provide an object picture or avatar that was not previously configured into the system. In this case the process may loop back to step 305 where the customer may be asked to physically enter an address into the field. In this case the address may not be saved by the system for use in any subsequent transactions. In one embodiment the customer may be prompted to add an address object to an online e-shop address book for an address that may be used by the customer more than one time over a period of time.

Assuming that all of the input addresses are known to or accessible to the system at step 311, the customer may input just a name or my drop a picture or icon into the field for each sub-quantity entered. It is important to note herein that an association may be made by the system between a sub-quantity of an item and an address or object representing an address. The system knows that the address is associated with the last sub-quantity entered, for example, by entering a sub-quantity for shipment and then subsequently providing the address.

At step 312, the customer determines when he or she is done configuring the ship-to order form. The process loops back to step 307 if the customer is not finished. The customer may proceed to checkout at step 306 if the customer is done configuring the multiple ship-to order at step 312. The rest of the process is the same as previously stated for a single transaction with a single ship-to address. Step 305 may immediately precede step 306 for a single shipping address for a single-address transaction or for a last shipping address for a multiple-address transaction. Step 305 may also immediately precede step 307 for a multiple address transaction where the address is not the last address to be entered or otherwise provided.

One with skill in the art will recognize that there may be more or fewer process steps 300 provided herein without departing from the spirit and scope of the present invention. The skilled artisan will also agree that the exact order of steps 300 depends in part of the nature of the transaction and on features provided. For example, step 313 may precede step 310 without changing the overall process.

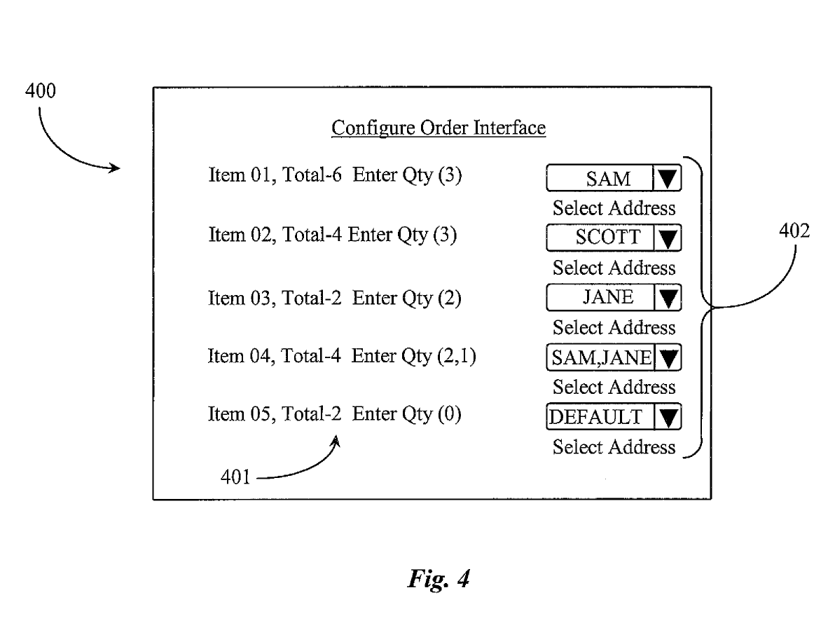

FIG. 4 is an elevation view of an interface 400 for configuring a multiple ship-to address order according to an embodiment of the invention. Configuration interface 400 is similar to ship-to order form or page 107 describe above with respect to FIG. 1 accept for that interaction with it is slightly different than what was previously described for page 1-7.

Interface 400 includes all of the line items 401 from a shopping cart. Each line item includes the item number, the total quantity, and at least on field for entering sub-quantities (smaller amounts of the total number). Each sub-quantity field is bounded by a parenthesis. To the right of line items 401, an array of dropdown menus 402 are provided. Dropdown menus 402 are each adapted to enable a customer to select one or more names from a common list of names that are each associated with a specific shipping address. The list may be an e-shop address book list provided by the customer and kept on file for the customer by the service. From time to time the customer may edit such a list as described earlier.

Referring to the top line of line items 401, item number 01 ordered by the customer totals 6 units. A customer may enter the number 3 within the parenthesis as is illustrated here. At far right of the top line, a top-most dropdown menu is used by the customer to select the person that 3 of the 6 units for product 01 will be shipped to. In this case, the customer has selected SAM. The system has access to the correlated pair of tuples (SAM=ADDRESS) where SAM is a printed name, an avatar, or a picture and ADDRESS is a physical address. SAM is the only address selected for item 01 sub-quantity (3). Therefore, the remaining 3 items will be shipped to a default address, presumably the address of the customer.

There are 4 total units for item 02 ordered and (3) entered for shipment to SCOTT. 1 remaining unit of item 02 will be shipped to the default address. There are 2 total units for item 03 and all of those items (2) will be shipped to JANE. There are 4 total units for item 04 and (2) will be shipped to SAM and (1) will be shipped to JANE. The customer enters 2 in the parenthesis and then selects SAM from the dropdown menu to configure the first amount. The customer then enters 1 in the parenthesis separated by a comma from 2 and selects JANE from the dropdown menu to configure the second shipment for that line item. In this way the system can keep track of what amount goes to what address. There are 2 units for item 05 and 0 is entered in the parenthesis indicating that all of those units will ship to the default address. Optionally the customer may select DEFAULT from the dropdown menu for that line. In one embodiment where all of the units are going to a single address for a line, the customer may leave the parenthesis blank and select the address from the dropdown menu.

Interface 400 can reside at the merchant server and can be interacted with by a customer as part of the transaction process where the names and addresses are pre-stored at the server for access. In one embodiment the interface resides on the server but the names and addresses are stored on the customer's computer but are accessible to the server by permission.

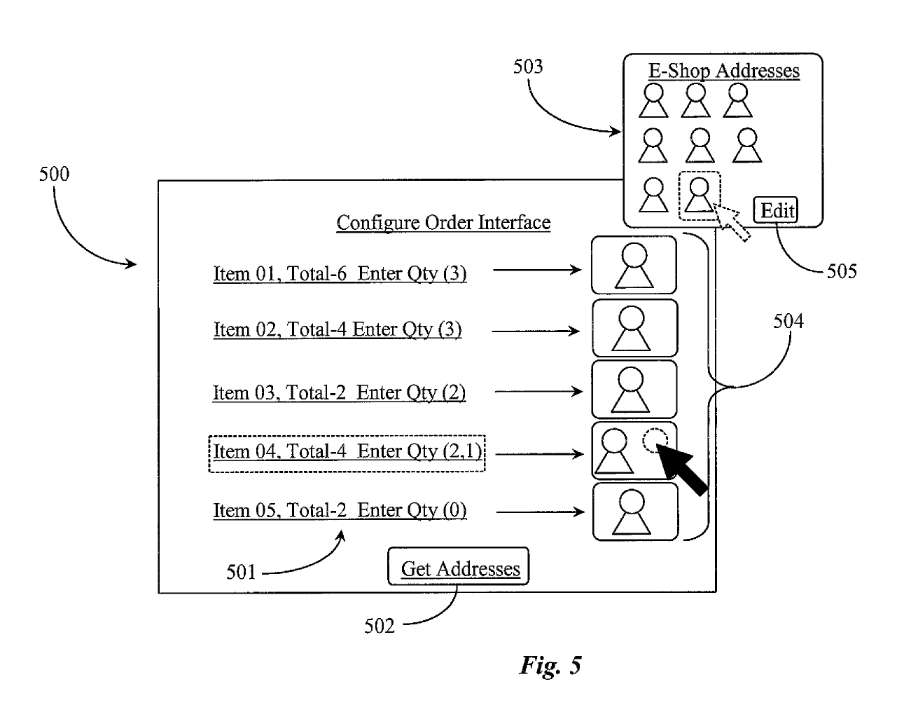

FIG. 5 is an elevation view of an interface 500 for configuring a multiple ship-to address order according to another embodiment of the invention. In this example the same order is being configured in the interface. Line items 501 are analogous to line items 401 of FIG. 4. Instead of selecting names from a dropdown menu, the customer inserts pictures or iconic representations into placeholders 504 in the order interface. There is one placeholder 501 for each line item 501.

In one embodiment a customer may first enter all of the sub quantities for each line item 501 in the provided parenthesis. When finished with the task, the customer may click on Get Addresses 502 provided as an execution link to an e-shop address book 503. E-shop address book 503 contains picture or iconic representation of the individuals for which shipping addresses are associated. In this case each picture or icon is an object that carries the address with it as an object attribute. The e-shop address book information may be stored server-side or locally with access permission to the information granted to the merchant. In this example, the user may drag and drop the objects from open book 503 directly into the provided object placeholders in the order interface. In this example line item 501 representing item 04 has two sub-quantities entered in the parenthesis. The customer can drag a picture from e-shop book 503 and drop the picture into the place holder for the first sub-quantity (2) and may drag a second picture from e-shop book 503 and drop the second picture into the place holder for sub-quantity (1) as is illustrated in this example using a pointer device (arrow) representation. The customer may edit any of the entries in book 503 by highlighting one and clicking an Edit function 505. Double clicking on any of the objects may enable view and edit of the individual address and representative picture, icon, or avatar.

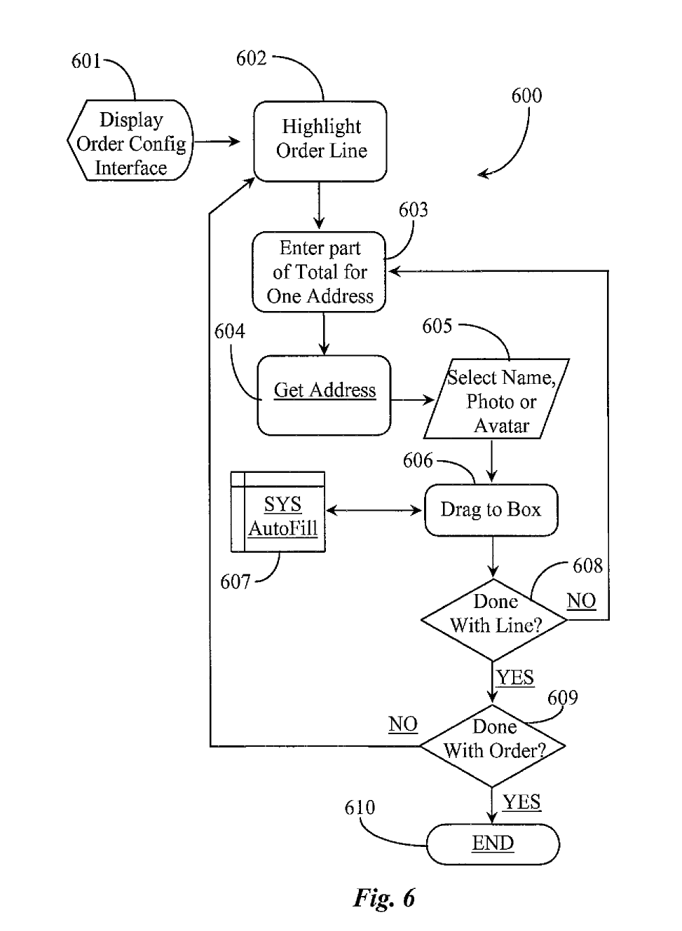

FIG. 6 is a process flow chart illustrating steps 600 for configuring an online order for multiple shipping addresses according to an embodiment of the invention. At step 601 a configuration order interface is displayed as a result of a customer indicating that a transaction will have multiple ship-to addresses. The configuration order interface may be analogous to those described in FIG. 1, FIG. 4 or FIG. 5.

At step 602 a customer may highlight any line reproduced from the shopping cart utility for beginning configuration. It is not required that a customer begin on a first line in the interface. At step 603 the customer enters a sub-quantity or smaller amount of the total units indicated for the item in parenthesis provided for the purpose. At step 604 the customer may “get” a ship-to address for that quantity entered by clicking on a button that causes an address book to open or a dropdown menu to appear for that line. At step 605 the customer may insert the address by dragging and dropping a representation (object) associated with an address into a provided placeholder. In one embodiment the customer may select a name from a dropdown menu. In another embodiment the customer may type a name into a field provided for the purpose. In one case the customer may have to type in an address if the address is not pre-configured into some address book or list.

At step 606 the customer inserts the address by dragging a picture, icon, or avatar from the address book into a placeholder (Box) provided. A dropdown menu may be provided instead of a placeholder in which case the address book does not have to be opened. At step 607 the system recognizes the representation of the address and auto fills the address into the order form for shipping. That is to say that the physical address will be printed on the order for that quantity for that line item when the ship-to order is generated for shipping purposes.

At step 608 the customer determines whether he or she is done with that line of the order. If at step 608 the customer is not done configuring that line then the process moves back to step 603 where the customer enters another amount. Step 604 does not have to be repeated. If the customer is done with the current line at step 608, the customer makes a determination whether or not the order configuration is finished at step 609. If the configuration is not complete at step 609, then the process may loop back to step 602 where a next line is highlighted for configuration. Configuration for each line involves specifying the smaller amounts of the total number of the item ordered and specifying the ship-to addresses for those smaller amounts. An error message may be generated and may pop-up on the customer screen if the total of smaller amounts entered on any line is greater than the total number of units ordered.

The customer determines that the order is complete when all of the lines are configured in the interface. The process then ends at step 610. Additional steps in the overall fulfillment process are not illustrated here but include submission of payment information, calculation of shipping and handling, order review and edit, and final order submission. There may be a confirmation step for accepting or rejecting the shipping and handling and options for changing shipping or for order reconfiguration.

In one embodiment of the present invention the system is provided on the side of the customer with the aid of a secure authentication device and the merchant does not have to incorporate any modifications in their proprietary or non-proprietary transaction fulfillment processes. Such a system is detailed below.

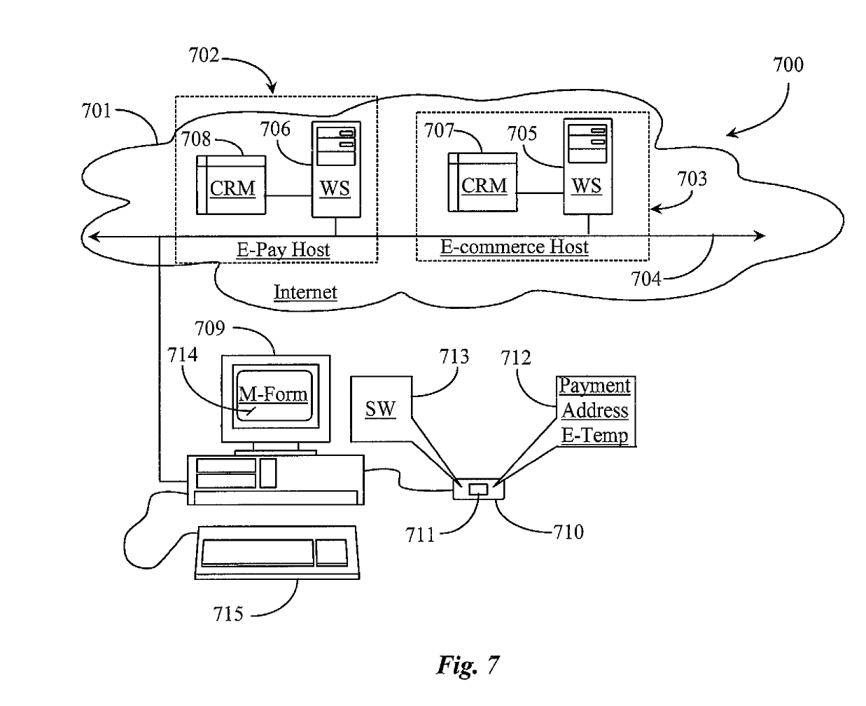

FIG. 7 is an architectural view of an online shopping network 700 according to another embodiment of the present invention. Shopping network 700 is similar in some respects to those networks described above but differs in some important aspects. Network 700 includes Internet network 701 as a carrier network. Internet network 701 is further represented herein by an Internet backbone 704, which represents all of the equipment, lines, access points, and any connected sub-networks that make up the network as a whole. As described above there are no geographic limitations on the practice of this aspect of the invention.

An e-commerce host 703 is provided and represents any entity that provides merchant services that can be accessed by customers connected to the Internet. Entity 703 has a Web server (WS) 705 connected to backbone 704 and a CRM system accessible to the server by data link. Web server 705 is analogous to e-shop server 101 of FIG. 1. CRM system is adapted to hold information about customers of the e-commerce host.

An e-pay host 702 is illustrated in this example and represents any entity that provides payment account services for customers using such accounts to purchase products online. Entity 702 has a Web server 706 connected to backbone 704 and a CRM system 708 accessible to the server by data link. Web server 706 is adapted to provide e-pay services and CRM system 706 is adapted to hold customer information related to their accounts, etc.

A customer may access network 700 using a network-capable computer 709 as was described further above relative to computer 100 of FIG. 1 and of FIG. 2. A secure peripheral device 710 is provided as a removably connectable drive to computer 709. Computer 709 serves as a host to peripheral device 710. Peripheral device 710 may be provided in the form of a Universal Serial Cable (USB) flash memory device that plugs into a USP port on computer 709. In one embodiment, peripheral device 710 is a unit that may be connected to computer 709 and may be recognized as a removable drive using a USB cable. Device 710 may also be adapted to communicate with computer 709 using wireless technology such as wireless infrared, Bluetooth™, Wi-Fi™, or some other protocol. In this example peripheral device 710 is a USB device.

Peripheral device 710 is adapted to hold information 712 including but not limited to customer payment information, address information (e-shop addresses), and an electronic template for configuring a shipping order similar to those already described. Peripheral device 710 also includes an executable software (SW) 713 adapted to enable device 710 as a server that may serve a configuration order interface, among other data, to a customer operating computer 709.

Information access and activation of peripheral device 710 is secured by an authentication mechanism 711, which may be a bio-metric scanner capable of authenticating a user by scanning a thumb or fingerprint and then checking the scan against a sample print stored on the device. Other types of authentication mechanisms may also be used instead of a print scanner. One example is a voice inflection or voice tone identifier.

A customer may connect peripheral device 710 to computer 709 but the device will not be accessible until the customer activates the device by performing an authentication using mechanism 711. One the device is “unlocked”, SW 713 may execute by default and serve a configuration form illustrated herein as multi-ship (M) form 714 displayed on the screen of computer 709. M-form 714 may also be referred to herein as an electronic shipping form or e-ship form.

To practice the invention according to this example a customer first connects to Internet 704, navigates to WS 705, and initiates an online order much in the same way as previously described above by browsing products, adding products to a shopping cart and proceeding to checkout.

In this embodiment the customer may activate peripheral device 710 when the customer is in a secure transaction session using secure socket layer (SSL) or other comparable security modes. Peripheral device 710 may be configured for access by the customer only for the purpose of retrieving information for use in an online transaction.

SW 713 may cause display of interactive form 714, which may contain several data fields for population. This form may run in the customer interface (browser) alongside a merchant order form. SW 713 may also be adapted to acquire any customer information already pre-filled into a merchant electronic order form or interface and auto populate similar fields in M-form 714. For example, all of the line items and information existing in the merchant form may automatically be scraped and pasted into subject appropriate fields in M-form 714. M-form 714 becomes the order configuration form and provided the ability to the customer to specify the shipping amounts of the line item totals and the shipping addresses for each specified amount as was described above relative to the online and computer resident versions of the interface.

SW 713 enables device 710 to serve the desired payment data stored securely on the device and auto fill the data into M-form 714. SW 713 enables the customer to open an electronic address book stored on device 710 to associate addresses with the entered item amounts in the M-form. When M-form 714 is completely configured for a shipping and payment order, the customer may click on the form, perhaps an option labeled “cross fill” data fields. This action results in specific information in the Multi-ship-to-form being automatically entered into subject appropriate fields in a merchant online order form. Payment information may first be entered on M-form 714 by the customer before it is automatically inserted into the online payment information form that requests the payment information for the transaction.

Shipping and handling charges are typically calculated on the merchant-side of the transaction. In this case shipping and handling is calculated on the merchant side as if the order has only one shipping address. SW 713 includes a routine for calculating shipping and handling for the case of multiple ship-to addresses entered as shipping destinations for the transaction on M-form 714. SW 713 obtains the shipping and handling charge calculation information from the merchant site and uses the same information to “re-calculate” the shipping and handling for the multiple shipping addresses entered on the M-form. The total shipping and handling charge for the split order will likely be more than any total calculated on the merchant side for the order. The customer may, from within the M-form, select cross-fill to cause the shipping and handling total calculated on the customer station to be inserted into the correct field in the online order form overwriting any previous data. The total charge for the online order is then recalculated and the total figure including sales tax (also figured per the multiple addresses) if any and shipping and handling is inserted into the total amount field in the online order form.

In this aspect of the invention no extra work or calculation is required of the merchant. As far as the merchant is concerned it is still a single transaction with extra shipping and handling and sales tax figured in for the multiple addresses, which are still only known to the customer side of the transaction. However, any combination of integration between merchant sites and customer software may be considered in the implementation of the system.

The customer may submit the order to the merchant from within M-form 714 thereby causing an order submission of the online order form with an attached form generated by M-form 714, which lists the shipping instructions for each subdivided amount of product. The shipping data is not cross-filled into the online order form because there are no appropriate fields to accept the data. Therefore, an attachment may be sent with the order as described. In another embodiment the online order form may be tagged with an electronic note detailing each item amount and where it is to be shipped.

The merchant may exercise an option to validate the re-calculated shipping and handling based on their own formula or chart and the attached or tagged shipping instructions after the order is placed to ensure correct calculation was performed on the customer side. However, this is not required as SW 713 uses the same criteria used on the site to account for these charges. In one case the merchant may advertise discounted shipping and handling for multi-ship to addresses if the recipients agree to accept email notices or other solicitations from the merchant. SW 714 may obtain this information automatically from the merchant site by parsing the data and may incorporate the discount into the customer-side calculation if appropriate.

In one embodiment the merchant may offer rebates on previously paid shipping charges to a customer if any of their ship-to recipients becomes a primary customer of the merchant and begins ordering products from the site. Such rebates can be credited to a customer's account with the merchant or deposited into a customer e-pay account by the merchant. There are many possibilities.

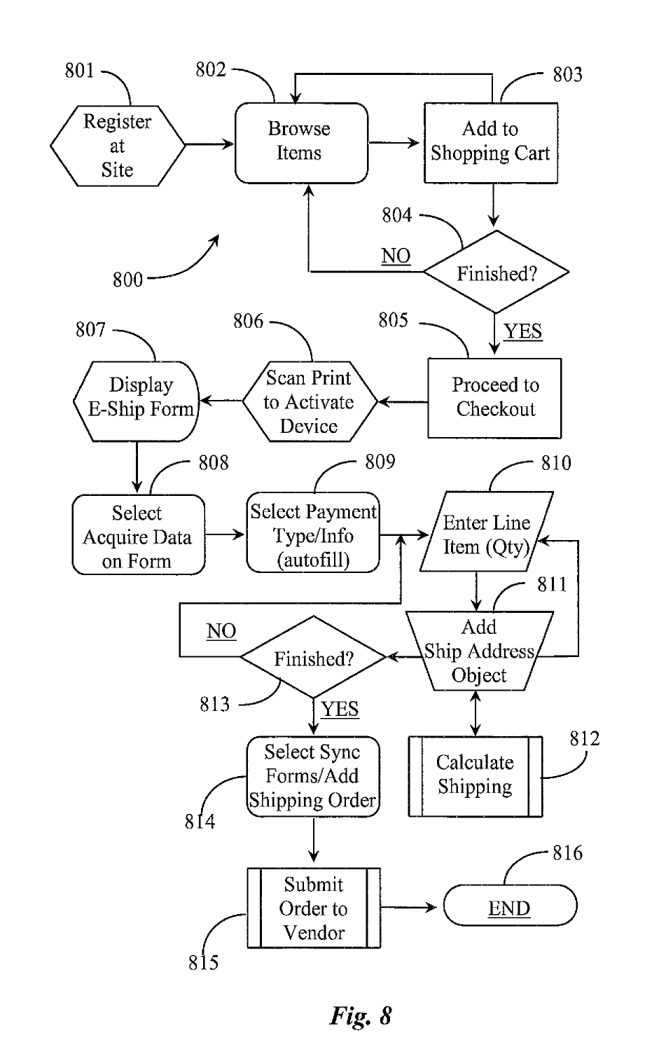

FIG. 8 is a process flow chart illustrating steps 800 for practicing multiple ship-to addressing for a single order according to the embodiment of FIG. 7. This process assumes that a customer has a peripheral device analogist to device 710 of FIG. 7 connected to a network capable computer station but not yet activated by the customer.

At step 801 the customer using a network-capable computer such as computer 709 described above connects online and navigates to a merchant site and registers (if not already a merchant customer) to shop at the site. At step 802 the customer accesses a product page or electronic catalog and browses the merchant items offered for sale.

At step 803 the customer adds items to an electronic shopping cart utility. The process may loop back to step 802 and back to step 803 until the customer decides at step 804 whether he customer is finished adding products. If the customer is not finished at step 804, the process loops back to step 802 until the customer decides in step 804 that he or she is finished. At step 805 the customer proceeds to checkout. The order page or (checkout) is a connection that is a secure connection protected by SSL and, perhaps other security measures. At step 805 the online merchant transaction or order form is automatically displayed.

At step 806 the customer may scan a finger or thumbprint on the peripheral device to activate the device and display the electronic shipping form analogous to M-form 714 described in FIG. 7. At step 807 the e-shipping form is displayed on the same computer screen as the online merchant's order form but in a separate window. The online merchant form may have some data about the customer and all of the shopping cart information displayed for review.

At step 808 the customer may select an option for acquiring data or “cross fill” while working within the shipping form displayed in step 807. This action results in specific data already in the merchant form being populated also into the shipping form. The data duplicated from the merchant form to the shipping form may include all of the customer data, the merchant information, and the shopping cart information.

At step 809 the customer may select a payment type from within the shipping form. The payment information of the customer is stored on the peripheral device and can be selected through a browse function from within the customer e-ship interface. The payment information may be auto-filled into the customer shipping form of FIG. 807. At this point in the process the customer is only working within the customer e-ship form, which contains the extra fields for configuring the multiple shipping addresses for subdivided product amounts.

At step 810 the customer begins configuring the multiple ship-to order from within the e-ship form by highlighting a line item and entering a smaller quantity of the total number of the ordered item into the provided field, which may be a set of parenthesis. At step 811 the customer may add a ship address object into a second field or object container provided. In this step the dropdown method can be used or a customer address book may be opened as described further above. However in this case the address information is stored locally on the peripheral device and can only be accessed by the customer. At step 812 shipping and handling and sales tax calculation may be provided as each new split is created. The process may loop back to step 810 and to step 811 until the customer decides whether or not the task is finished at step 809.

If the customer is not finished at step 809, the process loops back to step 810 and 811 until the customer is finished with the configuration task. In this aspect any of the previously described methods for specifying an address may be applied without departing from the spirit and scope of the invention. At step 813 if the customer decides the multi-ship-to configuration task is finished, the customer may select sync forms/add shipping order at step 814 while working still within the e-ship form. The actual name of the option may vary and is not relevant to the invention. Cross fill, synchronize, transfer data, or other names can be attributed to the option.

Execution of step 814 results in auto-population of payment info and total charge for the order into the merchant's order form the charge total considering all of the entered shipping addresses and amounts created in the e-ship form from the initial shopping cart figures. If a charge was calculated already in the merchant order form for a total for the transaction, that number is overwritten with the new data provided by the customer e-shipping form. The step (814) also results in a shipping instruction or order detailing each item sub-amount and the address that amount will ship to. The shipping instruction can be submitted with the order as an attachment or tagged to the order.

At step 815 the customer submits the order from within the e-ship form causing both the merchant order form and the special shipping instruction to be sent to the merchant as a new order to fulfill. At step 816 the process ends. The e-ship form may be automatically saved into a purchase history or order history folder set up on the peripheral device for records purposes. In the case of tracking numbers that a shipper or merchant may apply to each separate incidence of shipment for the order, those numbers may be emailed to the customer and/or the email addresses of each of the intended recipients of product if those addresses were provided. The customer may deactivate the peripheral device by performing a second scan operation on the device. This may close the SW and the device before the customer logs off of the secure connection to the merchant order page or checkout page. In this way, the important information of the customer is never stored on or accessible from the computer station with the peripheral device deactivated. The customer can safely connect the peripheral device to any virus free computer to make purchases online without worrying that any customer data including payment data address data or other important data will be left on the host device after disconnecting the peripheral device.

It will be apparent to one with skill in the art that the multi-ship-to order system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A system for facilitating data entry and submission of an Internet-based ecommerce transaction comprising:
a computing node having Internet access to an e-commerce server; and
a secure memory drive removably coupled to the computing node for storing payment information, address information, and an interactive interface for recording data into forms and cross filling data between two or more forms;
characterized in that the memory drive is activated by an authentication procedure during an online transaction such that after authentication, information stored on the drive can be used to complete, to record for receipt, and to submit an ecommerce order form using the interactive interface, the form submission including a supplementary electronic form detailing accounting of quantities of items ordered to be shipped to different shipping destinations.

2. A system for correlating specified quantities of items ordered in a single ecommerce transaction with shipping addresses comprising:
a server node hosting at least one ecommerce site connected to a network;
an electronic shopping cart utility accessible to the server node for listing line items and total quantities for purchase;
an electronic shipping interface accessible to the server node replicating each line item and quantity of the shopping cart utility and containing added fields in each line, at least one for specifying item sub-quantities and one for identifying a shipping address;
characterized in that the shipping interface calculates line item and total shipping charges for the transaction and correlates the correct item quantities to the correct shipping addresses.

3. A method for subdividing a single online order containing one or more line items to account for shipping and/or handling charges and item quantities to be shipped to more than one shipping address comprising the steps:
(a) defining the list of items and total quantities for each item ordered;
(b) for each line item, specifying sub-quantities for shipping to a destination address;
(c) for each line item of step (b), specifying the destination address for each sub-quantity;
(d) for each line item of step (c), calculating the shipping and/or handling costs for each sub-quantity and shipping address; and
(e) summing the shipping and/or handling cost sub-totals to account for the total shipping and handling charge for the order.

4. A method for transferring data between electronic forms stored on and served from disparate network storage devices comprising the steps:
(a) from a network connected computing node, accessing a server and invoking a first electronic form, the form containing pre-populated data in one or more data fields, invocation thereof resulting in display of the form including the data on a display screen of the network-connected computer;
(b) from the computing node of step (a), executing a program, the program serving a second electronic form, the program and form residing on a drive local to the computing node;
(c) auto filling data populated into the one or more fields of the first electronic form into one or more subject-appropriate fields of the second electronic form;
(d) inserting additional data into one or more additional fields of the second electronic form; and
(e) auto filling all or a portion of the additional data of step (d) into the one or more subject-appropriate fields of the first electronic form overriding any previous data in one or more of the fields.

5. A method for securing personal data for the purpose of later accessing the data for use in an online transaction comprising the steps:
(a) on a computer peripheral storage device, providing a user authentication device, at least one executable application and at least one rule specifying how authentication works to allow device and application access;
(b) connecting the peripheral storage device to a computer host;
(c) from the computer host, gathering personal data and offloading the personal data onto the peripheral storage device; and
(d) deactivating the computer peripheral device.
